(19) United States
(12) Patent Application Publication
(10) Pub. No.: US 2020/0201487 A1
(43) Pub. Date: Jun. 25, 2020

(54) Community-Based Collaborative Image Contribution System

(71) Applicant: Ambient Consulting, LLC, Minnetonka, MN (US)

(72) Inventors: Andrew Grossman, Hopkins, MN (US); Thomas Marlin, Maple Grove, MN (US)

(73) Assignee: Ambient Consulting, LLC, Minnetonka, MN (US)

(21) Appl. No.: 16/230,181

(22) Filed: Dec. 21, 2018

(51) Int. Cl. G06F 3/0481; G06F 3/0484; G06F 3/0486; G06F 21/62

(52) U.S. Cl. CPC G06F 3/0481; G06F 21/6218; G06F 3/0486; G06F 3/04842

(57) ABSTRACT

A system and method are presented that uses a computer database to define data concerning media items, media essays, users, and permissions for the users to modify the media essay data. A media essay data item identifies an ordered set of groupings, with each grouping containing media items and a textual description. The media items in one grouping are limited in number and arranged according to a selected one of a limited number of display patterns. A server uses the permissions data to allow a user to add an additional grouping to a media essay as defined by the essay data item. The additional grouping is originally presented in a distinguished manner at the end of the original groupings when the media essay is displayed. Only a user with sufficient permissions may alter the media essay to include the additional grouping.

### FIELD OF THE INVENTION

The present invention relates to the field of collaborative computing systems. In particular, the invention relates to managing collaborative contributions to a collective media-clustered work over a network through submission management and permission-based restrictions.

### BACKGROUND

The Internet has long hosted collaboratively generated content, such as Wikipedia. These systems allow multiple parties to work together to create a single work that is then shared with a wider audience. In some cases, however, community contributions must be restricted. Existing technological methods that allow community contributions are limited in their ability to allow un-reviewed modifications to be widely viewed while still separating these modifications from the remaining portions of the authoritative work. What is needed is submission management system that provides an ability to distinguish between potential modifiers of a work, that allows permitted third-parties to suggest modifications, that presents such modifications in a manner that does not distract from the original work, and that allows privileged authors the ability to incorporate portions of the submitted material into a new version of the original work. Allowing such collaborative computing in the context of media-focused essay works is especially needed.

### BRIEF DESCRIPTION OF THE DRAWINGS

FIG. 1 is a schematic view of a system implementing the present invention.

FIG. 2 is a schematic view of a media-clustered work managed by the system of FIG. 1.

FIG. 3 is a partial view of the media-clustered work of FIG. 2.

FIG. 4 is a flow chart showing a method for creating the media-clustered work of FIG. 2.

FIG. 5 is a flow chart showing a method of allowing privileged-based modifications to the media-clustered work of FIG. 2.

FIG. 6 is a schematic view of a first embodiment of a modified version of the media-clustered work of FIG. 2 including a third-party addition.

FIG. 7 is a schematic view of a new version of the media-clustered work of FIG. 2 after privileged modification incorporating aspects of the third-party addition.

FIG. 8 is a schematic view of a second embodiment of a modified version of the media-clustered work.

FIG. 9 is a schematic view of an annotated media item that may be used as part of the system of FIG. 1.

### DETAILED DESCRIPTION

### System 10

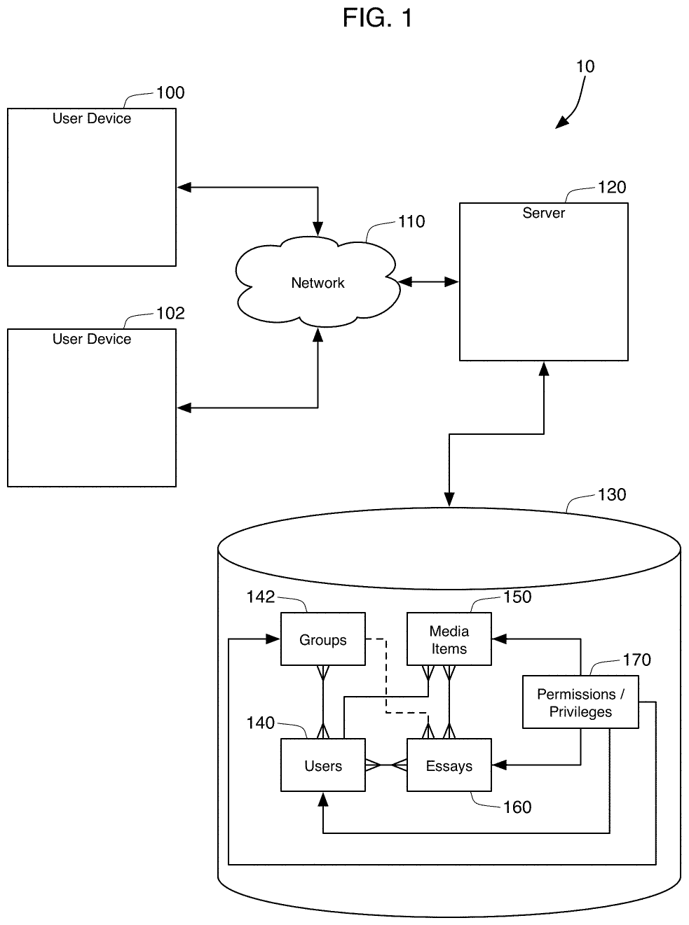

FIG. 1 shows a system 10 for implementing aspects of the present invention. In this system 10, multiple user devices 100, 102 are used to access a server 120 over a network 110. In this embodiment, the server 120 can take the form of one or more separate computers acting together to provide a server function over the network 110. The server 120 can take the form of a web server providing web pages, a server that provides other types of web services, or even a proprietary server that provides proprietary communications to remote computing devices 100, 102. In the preferred embodiment, the server 120 comprises one or more computing devices each containing a processor, non-volatile storage for data and programming, volatile RAM for handling data and programming during computing operations, and communication interfaces to communicate over the network 110. The processor may be a microprocessor, such as a CISC processor provided by Intel Corp. (Santa Clara, Calif.) or a RISC processor created pursuant to designs provided by Arm Holdings PLC (Cambridge, England). Generally, the server 120 will use an operating system such as those provided by Microsoft Corporation (Redmond, Wash.), Apple Inc. (Cupertino, Calif.), or open source UNIX-based systems such as Linux (trademark owned by the Linux Foundation of San Francisco, Calif.).

As shown in FIG. 1, the server 120 provides data and user interface elements to user devices 100, 102. Like server 120, the user devices 100, 102 will also take the form of computing devices with a processor, memory devices, and communications interfaces. Frequently, these devices 100, 102 will be portable devices, such as those running on the iOS operating system (Apple Inc. of Cupertino, Calif.), the Android OS (Google LLC of Mountain View, Calif.), or Windows 10 Mobile OS (Microsoft Corporation of Redmond, Wash.). The devices 100, 102 can also take the form of personal computers having a construction similar to the computing device(s) of the server 120.

The server 120 stores and retrieves data from a data store 130, which may take the form of a computerized database. This data store 130 may be, for example, a relational database comprising a plurality of related data tables, an object-oriented database comprising a plurality of objects, or a key-value data store. The content of the data store 130 will obviously vary according to the configuration of the data storage. In FIG. 1, this data content is represented abstractly. Each box 140-170 in data store 130 can be considered a data entity in the data store 130, and might represent a data table, an instantiated object, or a key-value pair. For the purposes of the following discussion, these data entities will be referred to as data “tables,” and lines between these boxes will be discussed as relationships between those tables.

In the embodiment shown in FIG. 1, the users operating the user devices 100, 102 are tracked in the data store 130 in the users table 140. Users must present proof of their identity to access the system 10, and the server 120 can compare such proof received from the user devices 100, 102 against authentication information stored in connection with entries in the user tables 140. The users tracked in user table 140 can be associated with one or more groups tracked in table 142. This association and other relationship between tables 140-170 in the database 130 is shown in FIG. 1 using crow's foot notation.

For ease in discussion, a record within a particular table 140-170 will also be referred to using figure numbers for the relevant tables 140-170. For example, FIG. 1 shows that each “user record 140” (as opposed to “each record in user table 140”) may be associated with one or more group records 142, and each group record 142 may be associated with one or more users 140. Similarly, at certain points in the following discussion a real-world entity that is identified by a record 140-170 within the database 130 may be simply identified using the figure number associated with that record 140-170. For example, the discussion might refer to “user 140” as opposed to “the user that is identified by a particular record in user table 140.”

A group record 142 will generally describe an actual grouping created by users of the system 10. For instance, one group may consist of users interested in the hobby of birding, while another group may be comprised of archeology professors that specialize in ancient Greece. In such a context, membership in a group might be closed, meaning that members are only allowed to participate in the activities of the group on system 10 after they have been accepted by at least one current member of the group. Programming on the server 120 will accept requests to join a group from one of the user devices 100, 102, and will submit that request to an administrator of the group as determined by the data records 140, 142 of the data store. Membership in a group will be established by the creation of a relationship between the appropriate records 140, 142.

One of the goals of the system 10 is the creation of media rich essays that are defined in the database 130 through essay records 160. These essays records 160 will invariably link to a plurality of media items 150. The media items 150 may take the form of images, video files or clips, PDF documents, audio files, or other form audio and/or video materials. The actual media materials may be stored in the data store 130 as an integral part of the media item data records 150, or may be stored external to the data store 130 and merely linked to by the media item records 150. Each essay record 160 can be associated with one or more user records 140 to indicate which users are the authors of the essay defined by record 160. In some cases, the essay record 160 may be associated with a group record 142 to indicate that the essay is created on behalf of, and is perhaps controlled by, a group defined by record 142.

The permissions records 170 (also known as the privileges records) are used by the server 120 to control the ability of users (defined by records 140) to access, use, and modify the media items 150 and the essays 160. A particular media item 150 may be associated with a user 140. In most cases, such an association would assign that particular user 140 as the “owner” of the media item 150. While the user 140 may not be the owner of the underlying media work in a copyright sense, the system 10 would assign the submitter of the media item as the owner. This means that the user 140 so assigned can modify the permissions record 170 associated with that media item 150 so as to control other users' ability to use, access, and modify that media item 150. Permissions 170 can also be assigned to essays 160, controlling access and modification privileges for the essays. In defining these permissions 170, the owner can define permissions for sets of users such as groups 142. For instance, the owner/user 140 may be considered a member of a group 142 in database 130. The user could create an essay 160 and give permission to view the essay 160 to all members of the group. A subset of those group members 140 may be given permission to suggest changes or to append additions to the essay 160, while a smaller subset may be given permission to make any edit to the essay 160. It is possible to create the same types of permissions sets without using group records 142. A user could identify multiple user records 140 that are given permission to suggest changes or append additions, and could identify other user records 140 that have permission to make any possible edit to the essay 160.

Furthermore, it is possible that some of the essay records 160 will be associated with permissions 170 that make the essay “public.” Public essays will allow contributions from all parties, with all users 140 essentially be given all possible permissions 170 to modify or change an essay 160. Of course, it can be problematic to allow all users 140 the ability to delete an entire essay 160, which might contain hours of input effort by multiple other users. As a result, some “public” essays will give users the right to add content to an essay 160, or perhaps make editorial changes to portions of an essay 160, but not give users the right to delete an entire essay 160 altogether. Alternatively, the creator of an essay 160 may reserve the right to may final changes to the essay 160 for themselves, but will allow anyone (even anonymous users) to add content suggestions to the essay.

### Essay 200

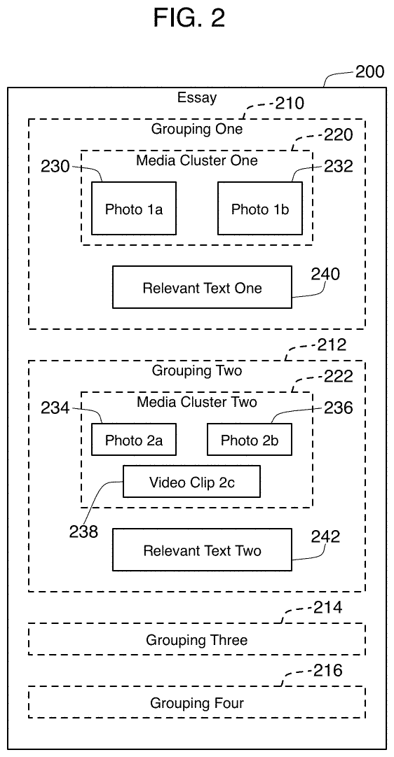

In the preferred embodiment, the media items 150 are grouped together by the essay data records 160 into clusters as is shown in the schematic drawing of a displayed essay 200 in FIG. 2. The displayed essay 200 can be presented by the server 120 to the user devices 100, 102. The essay 200 includes a plurality of groupings 210-216. The groupings 210-216 are presented contiguously, one after another, in FIG. 2. Grouping one 210 is shown with two parts, a media cluster 220 and relevant text 240. The other groupings 212, 214, and 216 of FIG. 2, also contain a media cluster 220 and relevant text 240 even though the details of grouping three 214 and grouping four 216 are not shown in the Figures. In some embodiments, the relevant text 240, 242 for each grouping 210-216 is optional.

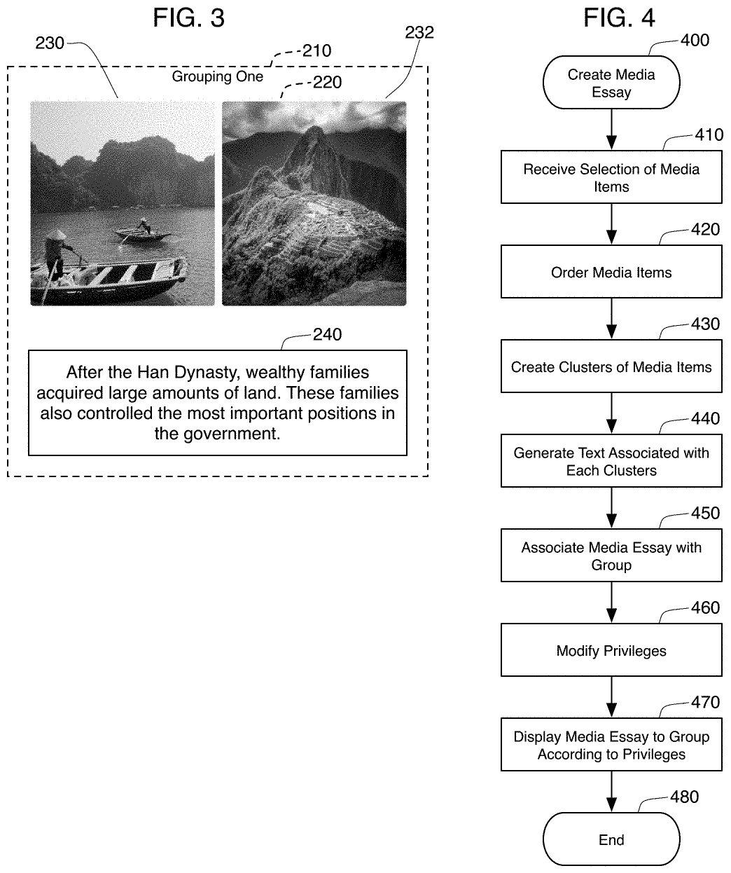

FIG. 3 shows the details of grouping one 210, including media cluster one 220 and relevant text one 240. Media cluster one 220 includes two different media items 150, namely photo la 230 and photo 1b 232. The media items 150 are considered part of a “media cluster” 220 because they are grouped together for display. Media cluster two 222 in grouping two 212 includes photo 2a 234, photo 2b 236, and video clip 2c 238. Each cluster 220, 222 generally contains a limited number of media items 150, such as two photos 230, 232 (as is the case with image cluster one 220), or two photos 234, 236 and a video clip 238 (as is the case with image cluster two 222). A cluster may contain only a single media item 150, but generally would not contain more than six or seven media items 150. Every cluster 220, 230 can be followed in the displayed essay 200 with a textual portion 240, 242. In the preferred embodiment, the textual portion 240, 242 contains a content that is related to, or describes, the media items 150 in its related cluster 220, 222.

A method 400 for creating the media-focused essay 200 of FIG. 2 is shown in FIG. 4. The method begins at step 410 with a user on a user device 100, 102 interacting with the server 120 to select a plurality of media items 150 as identified in the database 130. The selected media items 150 may comprise items 150 for which the user is the owner, or any items 150 for which the permissions 170 give the user 140 the right to use that item 150. Frequently, the essay 200 tells a story, either a chronological story of facts occurring through time, or a logical story or argument describing a concept or idea that has a beginning and a conclusion. In either case, the user will wish to organize the media items 150 into an order to be used in the essay 200, which occurs at step 420. Ideally, this is accomplished through a graphical user interface in which the selected items 150 are shown to the user, and the user can simply grab and drop the displayed items 150 to create a desired ordering.

As part of the ordering process, the user may also wish to make temporary modifications to one of these media items 150, such as the cropping of a photograph, the shortening of a video file, or the application of a filter to the item 150. In the preferred embodiment, these modifications can be made to the media items 150 and apply only to the context of the essay 160 being generated. Another user that uses that media item 150 for a different essay would not see or be required to use the same modifications.

Once the media items 150 are ordered, clusters 220, 222 are created by combining two or more media items 150 together in step 430. Again, this can be accomplished through the graphical user interface created by the server 120. The ordered items 150 are shown to the user, and the user can drag one item 150 onto another in order to cluster the items 150 together. As mentioned above, one embodiment will limit a cluster to contain no more than a maximum number of media items 150. This limit is normally established for esthetic reasons. A cluster 220, 222 that contains a small number of media content items 150 can be easily arranged in pleasing arrangements. For example, a cluster of three media items can be arranged in a row vertically or in a row horizontally. In addition, a cluster of three items can have one item on the left and two items stacked vertically on the right; one item on the right with two stacked vertically on the left; one item on top with two side-by-side below; or one item on bottom with two side-by-side on top. These various arrangements can be visually presented to the user 140 by the server 120 in order for the user to select the desired display arrangement for each cluster. A larger cluster of 5, 6, or 7 images could be arranged in vast number of arrangements, which may unnecessarily complicate the development of an essay 160. Consequently, an embodiment might limit the number of media items 150 per cluster 220, 222 to three or four. The selection of the desired display configuration can be made when each cluster 220, 222 is created in step 430. In FIG. 3, cluster 220 consists of two images arranged side-by-side.

In step 440, text 240, 242 is added for each cluster 220, 222. It is preferable that the text be relevant to or descriptive of the media cluster 220, 222, but this is not a requirement. The media clusters 220, 222 and their associated text entries 240, 242 can be considered collectively to constitute the groupings 210, 212. The entry of text at step 440 for each cluster 220, 222 is optional. It some cases, textual commentary is not unnecessary for a media cluster 220, 222 as the media items 150 of the cluster 220, 222 do not need any textual embellishment. In other cases, two clusters can be viewed by a user as forming a single cluster by skipping any textual input 240, 242 for the first of the two clusters. In FIG. 2, for example, if relevant text one 240 were blank, media cluster one 220 and media cluster two 222 might be visually seen as a single cluster of five media items 150 having a single relevant text portion 242. By allowing the use of “stub” groupings (groupings 210-216 that do not contain any text 240, 242), stricter limits on the number of media items in a cluster 220, 222 can be imposed. For instance, a limit of three media items 230-238 per cluster 220, 222 is not unduly limiting with this ability to combine clusters 220, 222, and it greatly simplifies the potential display configurations that need to be selected during the creation of the clusters 220, 222 in step 430.

After step 440, the essay 200 may be considered complete. Nonetheless, method 400 continues with the association of the essay 200 with a group (defined by database entry 142) in step 450. Associating an essay 200 with the group 142 aids in the assigning of privileges/permissions 170 in step 460. As explained above, a particular essay 200 may be made available for viewing by all users, but the right to append additional groupings (see below) will be limited to members of one group 142. Users outside the group will not be able to modify the essay 200. Additional editing of the essay 200 will be limited to a subset of the group 142, or maybe to the particular user 140 that created the essay 200 (the owner of that essay 200). Once the group is assigned and the privileges are established, step 470 then displays the created essay 200 to the group and other users according to these assigned permissions 170.

### Modified Essay 600

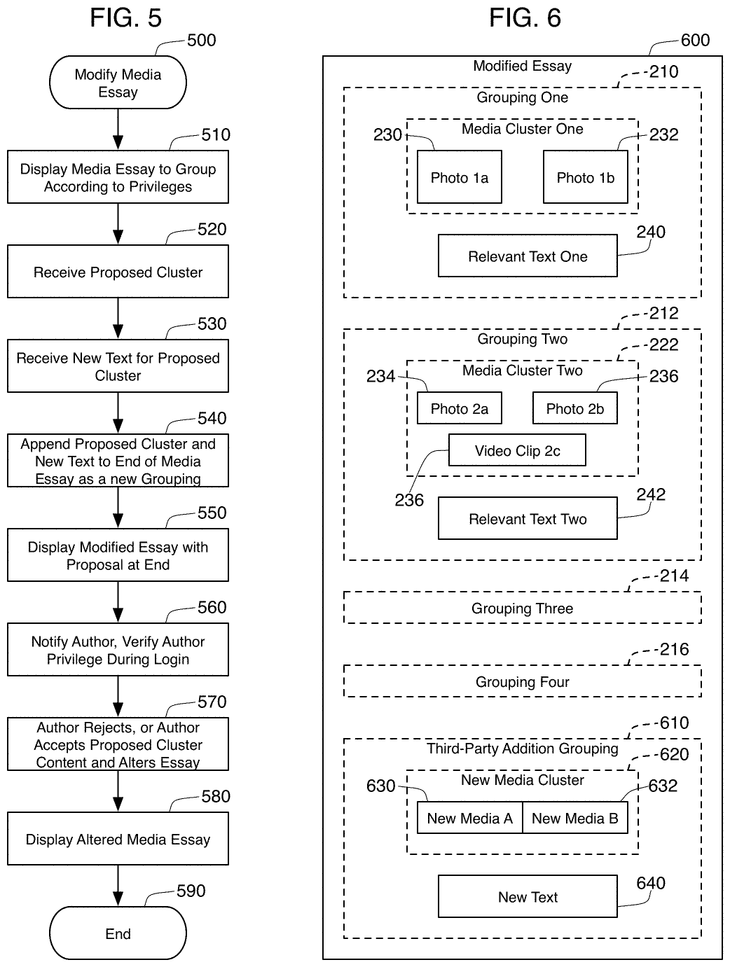

As mentioned above, the permissions 170 may allow for some users to modify the media essay 200. Method 500 shown in FIG. 5 shows one technique for allowing such modifications. The method 500 begins at step 510 with the displaying of the media essay 200 in accordance with the assigned privileges 170. This is the same as step 470 of FIG. 4. At step 520, a user with permission to add a grouping to the essay 200 submits a proposed cluster of media items 150, which is received by the server 120. This proposed cluster can be created in a manner similar to that describe above, with the user selecting media items 150, ordering the items 150, modifying (i.e., cropping) the items 150, and then selecting a display configuration for the items. In addition, the server 120 will receive from this user new text for this proposed cluster at step 530.

The cluster and new text are then appended at step 540 to the essay 200, forming a modified essay 600 as shown in FIG. 6. Modified essay 600 contains the first four groupings 210, 212, 214, and 216 from essay 200 unmodified. The new grouping is the third-party addition grouping 610, shown appended beneath these other groupings 210-216. This new grouping 610 includes the cluster 620 received at step 520, and the new text 640 received at step 530. As shown in FIG. 6, the new media cluster 620 contains new media item A 630 and new media item B 632. At step 550, this modified essay 600 is displayed to users.

In one embodiment, the third-party additions 610 to an essay 600 will be distinguished during the display of the essay 600 so that users will be able to identify the media content 630, 632 and the text 640 as being a proposed addition that has not yet been evaluated or accepted by the user or users that have sufficient permission to edit the entire essay 600. In this way, collaborative additions to the media-focused essay 200 may be made by users identified by records 140 who have only partial permissions 170 to the essay database entry 160 in database 130. These users are not allowed to modify the original essay 200, but they can propose one or more additional groupings 610. In this way, other users can view the modified essay 600, see the original groupings 210-216, and view all third-party addition groupings 610. In some cases, these other users can select a preference to hide third-party addition groupings 610 that have not yet been approved and incorporated into the essay. In these cases, only the original essay 200 will be displayed even though an addition grouping 610 has been added to the essay 200.

In some circumstances, there will be many third-party suggestions 610 for a particular modified essay 600. If all of these suggested groupings 610 were displayed during the display of a modified essay 600, it could overwhelm the experience created by the original essay 200. One method for dealing with a large number of suggested groupings 610 is to sort the groupings based on the quality of each suggested grouping 610. Quality could be based on user reactions to the content of these groupings 610. Users could be allowed to rate the groupings 610, such as by using a number scale or a simple thumbs-up/thumbs-down rating. The system 10 could also track clicks or exploded views of the content 630, 632, 640 for each grouping 610 to determine a popularity score for the grouping 610. It is also possible that a quality rating could be added to each addition grouping 610. Groupings with original content (images or media not found elsewhere in this essay 200 or even elsewhere on the Internet), with more content, or that are otherwise more complete would be given a higher quality rating. The highest ranked groupings 610 (as determined by one or more of these measures) could be displayed first on the modified essay 600. Lower ranked groupings 610 would be displayed last, or even removed from the public display of the modified essay 600.

In other cases, only a predetermined number of third-party addition groupings 610 could be added to the modified essay 600. Once the limit has been reached, method 500 would not allow the creation of additional groupings 610 for this essay 600. Alternatively, rather than locking out new groupings 610, older groupings 610 could be removed from the public display of the essay 600 every time a new grouping 610 is added.

### Altered Essay 700

Other users identified by user records 140 will have greater privileges to modify the essay records 160 as defined by permissions 170. These users will have the ability to modify the entire essay 200, 600, and can be considered “authors” of those essays 200, 600. As explained above, the privileges database entities 170 are responsible for assigning author and owner privileges to essay database entities 160, for determining which groups 142 (and, in turn, which users 140 affiliated with those groups 142) will be given permission to view the essays 160, and which groups 142 will be given permission to suggest additional groupings 610 to the essays 160.

When a proposed cluster has been received at step 530, a notification will be sent to the authors of that essay 200 (step 560). When a user 140 logs into the system 10 to review the proposed change and modify the essay 200, the system 10 will verify the user's author status (also step 560) using the permissions database records 170. At this point, the author user is granted to the ability to modify the essay 600, such as by incorporating some or all of the content of the third-party addition grouping 610 into the rest of the essay 600. The author also has the ability to reject the third-party addition grouping 610. If this grouping 610 is rejected, the essay 200 returns to the form shown in FIG. 2.

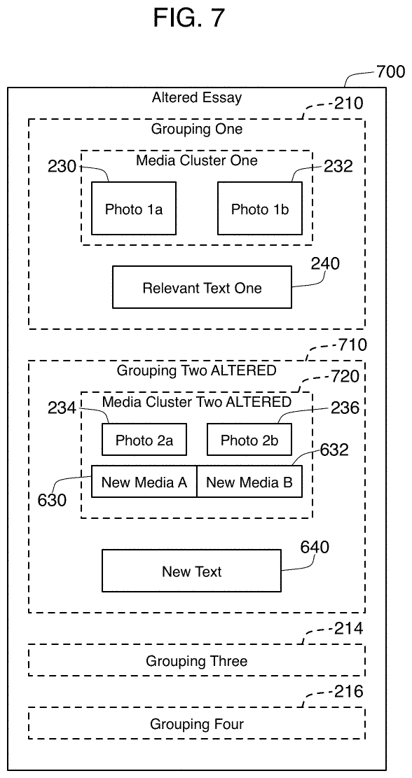

The author's rejection or acceptance occurs at step 570. If the author accepts the proposed changes, the acceptance and modification of the original essay 200 results in an altered essay, such as the altered essay 700 shown in FIG. 7. In this altered essay 700, the author user has taken the media items 630, 632 from the new media cluster 620, and included those items 630, 632 in an altered version of media cluster two 720. In effect, these items 630, 632 replaced the video clip 2c 236 in media cluster two 222. In addition, the new text 640 has replaced the text two 242 that used to form part of grouping two 212. This new, altered media essay 700 is then displayed by the server 120 to other users at step 580, and the method ends at 590.

If the author rejects the proposed changes, the system 10 can allow the author to make suggestions that would make the proposed addition grouping 610 acceptable. For example, the author may suggest that the media 630, 632 included in the addition grouping 610 be fully identified. As explained below, it is possible that the media items 150 included in the system 10 be annotated media items 900 that include embedded metadata and other information. The rejection made by the author in step 570 may include a suggestion to fully annotate the suggested media items 630, 632. In such an embodiment, the system 10 will transmit messages between the authors and the suggesting users 140. Suggestions for improvements, or reasons for rejections, can be communicated to allow the suggesting user to re-submit an improved version of their rejected addition grouping 610.

In some embodiments, the author will be given a limited time after receiving the notification at 560 to log into the system 10 and create the altered media essay 700. If the author fails to review the third-party addition grouping 610 within that time frame, the grouping 610 will be automatically accepted as a normal part of the essay. Of course, the author retains editing rights, and can choose to remove the grouping 610 at a later time.

In one embodiment, a user that suggests a third-party addition grouping 610 can specify how they believe that this grouping should be used to create the altered essay 600. For example, the user creating addition grouping 610 could have specified that the new media items 630, 632 should replace the video clip 2c 236 in grouping two 212, and that the new text 640 should replace text 242 in that same grouping 212. The author doesn't need to accept those suggestions, but the ability to include the suggestions will greatly aid the author in creating the altered essay 700. Even with those suggestions, however, the modified essay 600 will visually distinguish the new grouping 610 (such as by placing the new grouping 610 at the bottom of the essay 600 and/or by highlighting or shading the new grouping 610) until the author has accepted and incorporated the new grouping 610 in the altered essay 700.

In some embodiments, the essay 200, 600 may contain multiple parts or sections. For example, an essay on Arctic animals may contain a part or section on polar bears. In the context of essay 200, perhaps groupings one 210, two 212, and three 214 comprise the polar bear section. In these cases, a user wishing to suggest an addition grouping 610 may have the ability to assign their suggestion to the particular part or section that discusses polar bears. Rather than locating the proposed addition grouping 610 at the bottom of the entire essay 600, the addition grouping 610 could be visually located at the end of the polar bear section. In further embodiments, the proposed addition grouping 610 could be placed at the bottom of the essay 600 as shown in FIG. 6 when the modified essay 600 is shown to the general public, but be moved to the appropriate section when the author is determining whether to include or delete the proposed addition grouping 610 in the altered essay 700.

### Alternative Embodiment Modified Essay 800

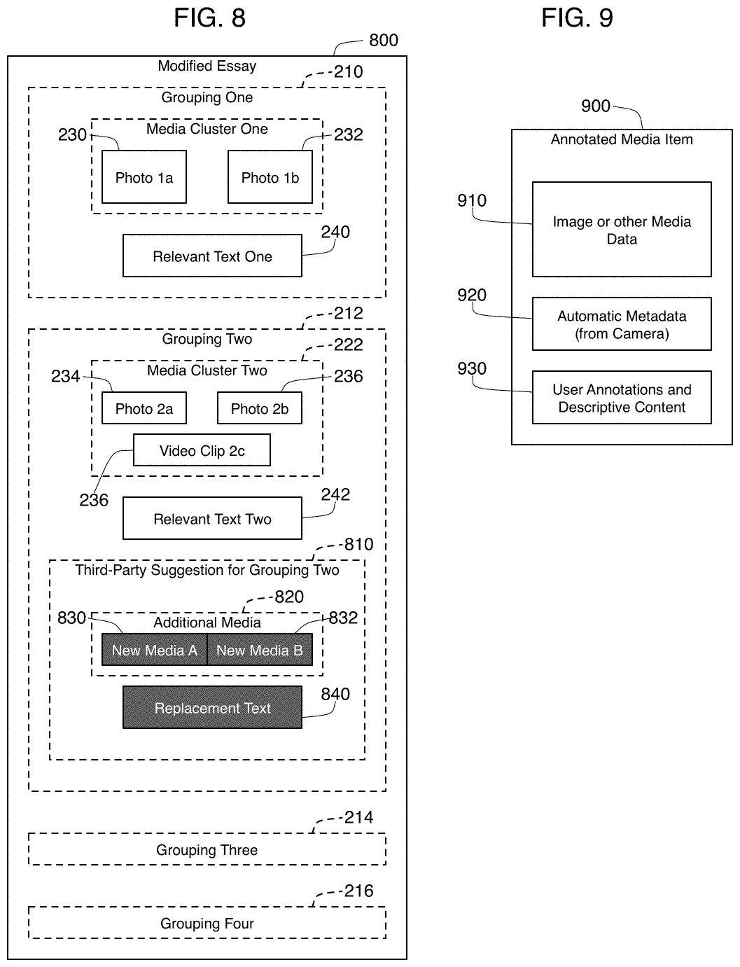

In still other embodiments, the system 10 will not place third-party proposed groupings 610 at the end of the chapter or essay 600, but may allow the user suggesting the addition to place the new grouping 610 anywhere within the essay 600. As long as the addition grouping 610 is visually distinguished from the original groupings 210-216, users will not be fooled into thinking that the addition grouping 610 was created by, or accepted/endorsed by, the authoring user or group. For example, FIG. 8 shows another embodiment of a modified essay 800. This is similar to the modified essay 600 described above in connection with FIG. 6. However, where the proposed changes in FIG. 6 related to an addition grouping 610 that was temporarily located at the end of modified essay 600, the proposed changes in FIG. 8 relate to a third-party suggestion 810 specifically identified for grouping two 212. The suggestion 810 includes additional media 820 for the media cluster two 222. In particular, the suggestion 810 proposes that Media A 830 and Media B 832 be added to cluster 222. In addition, the suggestion 810 includes replacement text 840 that the third-party intends will replace relevant text two 242 in grouping two 212. Because the third-party has identified that these changes be made to grouping two 212, the modified essay 800 created before the author creates the altered essay 700 inserts this suggestion 810 proximate to (or even within) grouping two 212. Because this suggestion 810 has not been approved by the author of the essay 200, the suggestion 810 must be visually distinguished from the rest of the content in modified essay 800. In FIG. 8, this is shown by inverting the black and white colors for media 830, 832, and replacement text 840. Obviously, such inversion is not the only technique possible to visually distinguish the suggested content 830, 832, 840.

In the embodiment described above, the altered essay 700 incorporated the content of the third-party addition grouping 610 by modifying one of the original groupings, namely grouping two 212. In other cases, the third-party addition grouping 610 will be added to the essay 200 as a new grouping without changing any of the original groupings. The new grouping 610 could be inserted at any location within the ordered set of original groupings 210, 212, 214, 216, including at the first position or at the last position. If the third-party addition grouping 610 is accepted into the last position by the author user, the altered essay 700 would appear very similar to the modified essay 600. In at least one embodiment, the two essays 600, 700 would differ in that the server 120 would distinguish the addition grouping 610 in modified essay 600 as having not been accepted by an author user (such as through highlighting or shading of the entire grouping 610, or by using some other type of visual indicator or flag near the beginning of the grouping 610), while there would be no distinguishing of this grouping 610 in the altered essay 700. In another embodiment, the author can identify accepted contributions by using some other kind of visual distinction, such as a label on or near the grouping 610 indicating that the grouping 610 has been accepted.

### Annotated Media Item 900

FIG. 9 shows one embodiment of an annotated media item 900 that could be used to implement the media items 150 of FIG. 1. An annotated media item 900 contains the actual audio-visual media data 910 that is viewed by a user. This may take the form of an image, a video file, an audio recording, or other type of audio-visual media. In most cases, this media data 910 is encoded using a codec, such as the h.264 codec for video files, the mp3 codec for audio files, or a PNG or SVG format for image files. It is the media data 910 that is accessed for presenting the media items 150, 900 for display in a media essay 200.

In one embodiment, the annotated media item 900 also contains information about the media data 910. Some of this data (or metadata) 920 is automatically generated during the process of creating the media data 910. For example, this automatic metadata 920 may contain data created and stored by the camera when an image or video is created. This may include the date, time, and location indicating when and where the media data 910 was acquired. Information about the camera settings, the codec parameters, and other information may also be stored in the automatic metadata 920. This automatic metadata 920 can be used when presenting the media item 900 in an essay 200. For example, the time and date information, or the GPS coordinates, from this data 920 could be displayed inside the media cluster 220 when the media item 900 is displayed. Alternatively, this information could “pop up” when the user hovers over or selects the media item when viewing the essay 200.

In addition to the automatic metadata 920, the annotated media item 900 contains user annotations and other descriptive content 930. Because a media item 150 can be used by multiple users, and exist inside multiple essays 160, each media item 150 may be viewed by multiple users in a variety of contexts. Multiple users viewing a media item 150 may have useful and insightful commentary about the photograph that would be valuable if shared at all the other locations where the media item 150 is used. To allow the sharing of such information about a particular media item 150, the annotated media item 900 allows for and tracks user annotations 930 about the media item 900. A user may have information about the origin of the photo, or the people shown in the photo, or the purpose for which the people in the photo were gathering. When the annotated media item 900 is presented within a media essay 200, the user annotations 930 for the photo can be made available to the viewer of the media essay 200, either by presenting the annotations 930 visibly next to the media content 910, or by hiding the annotations 930 originally and then presenting the annotations 930 when the media item 910 is selected (or hovered over). In another embodiment, the user annotations 930 for an annotated media item 900 will be presented to the user that is creating the essay as default text within the relevant text 240, 242 portion of the grouping 210-216 being created by the user. The user can then accept those annotations 930 for the relevant text 240, 242, edit those annotations 930 while creating the relevant text 240, 242, or simply ignore and delete that text.

The use of an annotated media item 900 in a media essay 200 allows a user another way to contribute to the essay 200 other than the addition grouping 610. Users can be given permission to add a comment to the annotations 930 of a particular annotated media item 900, or to correct or amend an annotation 930 that is already associated with that media item 900. Permissions for altering these user annotations 930 can be given by the permissions data records 170. These permissions 170 can be set by the user associated with the user record 140 identified as the owner or author of a particular media item record 150. It is therefore possible to have different permissions to add content to an essay 200 for a single user. That user may not be allowed to modify or alter the essay 160 as a whole, but is allowed to modify or alter the user annotations 930 for a particular annotated media item 900 included within the essay.

The preceding paragraphs describe a system in which a contribution to an essay 200, usually in the form of a suggested additional grouping 610, is immediately viewable to other viewers by changing the essay 200 into a modified essay 600. In the modified essay 600, the additional grouping 610 is visually distinguished from the original groupings 200-216 of the essay 200. In an alternative embodiment, an author may elect to allow contributions and suggestions to their essay 200 (such as in the form of an additional proposed grouping 610), but may choose to keep such contributions private. This election for private suggestions can made while establishing the other privileges for an essay 200, as described in connection with step 460 above. The system 10 would determine whether the election for private suggestions has been made when displaying the essay 200 by simply accessing the privileges 170 associated with a displayed essay 160. When an essay accepts only private suggests, a user may still suggest a new grouping 610, but the modified essay 600 with unapproved, proposed suggestions 610 will not be shown to viewers of this essay 200. The author will still be notified of the proposed changes 610, and the author can accept or reject the proposed changes as described above in connection with step 570. If some or all of the proposed changes 610 were accepted or used by the author, the altered essay 700 would then be shown to the viewing public.

### Group Owned Essays

As shown in FIG. 1, users 140 can be associated in the database 130 with one or more groups 142, while each group 142 can be associated with multiple users 140. The above description assumes that one or more users 140 are associated with a particular essay 160 as authors of the essay 160. The dotted line in FIG. 1 also shows that groups 142 can take on a direct role for an essay 160. In one embodiment, groups 142 “sponsor” essays 160, which means that the groups 142 take control of (or ownership over) the essay 160. Such ownership gives the group 142 ultimate control over the content of the essay 160.

The groups 142 in the system 10 may include academic groups, such as professors of Greek archeology. This group 142 may wish to create a group-sponsored essay within their area of expertise, such as an essay on archeological findings related to the Peloponnesian War. When an essay 160 is controlled by such a group, the essay 160 can take on a special role within the system 10. Users can assume that the essay 160 has achieved a high level of dependability. Of course, the level of dependability given to the essay 160 by the user 140 will depend on the user's opinion of the sponsoring group 142. Nonetheless, one embodiment of the system 10 treats group-sponsored essays 160 differently than essays 160 created by one or more individual users 140. Group-sponsored essays 160 can be considered “official” essays 160 of the system 10, while user-created essays 160 might be considered “amateur” essays 160. The system 10 can then rank official essays 160 more highly in responding to searches of the essays 160 by users 140. Alternatively, official essays 160 can be visually distinguished from non-sponsored essays 160 when being displayed.

By sponsoring an essay 160, the group 142 has ultimate control over the content of the essay 160. In one embodiment, this control includes the ability of the group 142 to assign certain user members 140 to act as editors for the essay 160. These editors take on the role of the author in the above-described methods. Of course, the editors serve at the pleasure of the group 142 as a whole. The group 142 retains the ability to change which users 140 are considered editors for any essay 160 that is sponsored or owned by the group 142. Of course, the group 142 is ultimately controlled by users 140 that act as officers or owners of the group 142, and act on behalf of the group 142. These officer users 140 can change over time (such as via elections or resignations), but the group 142 and the control that the group 142 has over sponsored essays 160 does not change.

In some cases, an essay 160 may be created by an individual user 140 that is related to the interest area of a group 142. The users 140 may even be members of the group 142 within database 130. Nonetheless, the essay 160 will be considered an amateur essay 160 by the system 10. To obtain sponsorship of their essay 160, the authors 140 must submit the essay 160 to the group 142 to be considered for sponsorship. The system 10 may provide an interface that allows the authors 140 of an essay 160 to formally submit the essay 160 to a group 142. The group 142 can examine the essay 160, and, if desired, the group 142 can take over the control of the essay 160 by formally sponsoring the essay 160. This sponsorship step will also be made through the user interface of the system 10. Once the group 142 has sponsored the essay 160, the group 142 can name the original author or authors 140 of the essay 160 as the editors for that essay 160. Alternatively, the group 142 may name other users 140 as the editors for the essay 160.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method for managing a computing system to handle contributions to a collaborative, media-based work, the method comprising:
a) at a computer server, establishing a data store comprising:
i) user data entities identifying users,
ii) media item data entities identifying media items,
iii) essay data entities that define media essays including an ordered set of groupings, with each grouping identifying at least one media item data entity and having a textual description data entry, and
iv) permission data entities defining user privileges to modify the essay data entities;
b) at the computer server, displaying a first media essay defined by a first essay data entity to a first user, the first essay data entity identifying an ordered set of original groupings;
c) at the computer server, identifying the first user as being associated with a first user data entity, and further using permission data entities to verify that the first user data entity has permission to add an additional grouping to the first media essay while further verifying that the first user data entity does not have permission to alter the original groupings;
d) at the computer server, receiving from the first user the additional grouping identifying additional content, the additional content comprising an additional media item data entity and an additional textual description;
e) at the computer server, modifying the first essay data entity to incorporate the addition grouping;
f) at the computer server, displaying a modified essay defined by the modified first essay data entity to a second user, the modified essay displaying the ordered set of original groupings with the additional grouping being visually distinguished from the original groupings.

2. The method of claim 1, wherein the additional grouping is visually distinguished by appending the additional grouping to the end the modified essay.

3. The method of claim 2, wherein the additional grouping is further distinguished through the use of a visual indicator.

4. The method of claim 1, wherein the additional grouping is distinguished by changing the presentation of the additional grouping using a technique selected from a set consisting of highlighting the additional grouping or shading the additional grouping.

5. The method of claim 1, wherein the first media essay contains multiple chapters, and further wherein the additional grouping is visually distinguished by appending the additional grouping to the end of a selected chapter of the modified essay.

6. The method of claim 1, further comprising:
g) at the computer server, receiving a request from an author user associated with an author user data entity to alter the original groupings;
h) at the computer server, using permission data entities to verify that the author user data entity has permission to alter the original groupings;
i) at the computer server, altering one of the original groupings to incorporate the additional content; and
j) at the computer server, displaying an altered essay including the altered one of the original groupings.

7. The method of claim 1, further comprising:
g) at the computer server, receiving a request from an author user associated with an author user data entity to alter the original groupings;
h) at the computer server, using permission data entities to verify that the author user data entity has permission to alter the original groupings;
i) at the computer server, altering the modified first essay data entity to insert the additional grouping into the ordered set of original groupings; and
j) at the computer server, displaying the altered essay defined by the altered modified first essay data entity.

8. The method of claim 1, wherein the first essay data entity further identifies a stub grouping without any textual description along with the ordered set of original groupings.

9. The method of claim 8, wherein the stub grouping is displayed immediately before one of the original groupings so as to visually combine the media items from the stub grouping with the media items from the subsequent one of the original groupings.

10. A method for creating a media essay comprising:
a) at a computer server, establishing a data store comprising:
i) user data entities identifying users,
ii) media item data entities identifying media items, and
iii) essay data entities that define media essays including an ordered set of groupings, with each grouping identifying at least one media item data entity and having a textual description,
b) at the computer server, receiving a selection of media items;
c) at the computer server, displaying the selection of media items in a user interface;
d) at the computer server, receiving ordering instructions through the user interface via a drag and drop command to reorder the selection of media items;
e) at the computer server, displaying the reordered selection of media items in the user interface;
f) at the computer server, receiving clustering instructions through the user interface to cluster the media items into media item clusters no larger than a predetermined number of media items;
g) at the computer server, presenting possible display configurations for the media item cluster, the possible display configurations being determined by the number of media items in each media item cluster;
h) at the computer server, receiving at least one desired display configuration for at least one media item cluster;
i) at the server computer, receiving textual entries for each of a plurality of media item clusters;
j) at the server computer, combining the media items clusters and their textual entries into an ordered set of groupings and storing this data in a first essay data entity in the data store; and
k) at the server computer, displaying the media essay defined by the first essay data entity by displaying the ordered set of groupings, with each grouping being displayed by displaying the media items in the media item cluster according to the desired display configuration and displaying the textual entry for the media item cluster adjacent to the media item cluster.

11. The method of claim 10, wherein the predetermined number of media items is four.

12. A method for managing a computing system to handle contributions to a collaborative, media-based work, the method comprising:
a) at a computer server, establishing a data store comprising:
i) user data entities identifying users,
ii) media item data entities identifying media items,
iii) essay data entities that define media essays including an ordered set of groupings, with each grouping identifying at least one media item data entity and having a textual description, and
iv) permission data entities defining user privileges to modify the essay data entities;
b) at the computer server, displaying a first media essay defined by a first essay data entity to a first user, the first essay data entity identifying an ordered set of original groupings;
c) at the computer server, identifying the first user as an anonymous user unassociated with any user data entity;
d) at the computer server, receiving from the first user the additional grouping identifying additional content, the additional content comprising an additional media item data entity and an additional textual description;
e) at the computer server, modifying the first essay data entity to incorporate the addition grouping;
f) at the computer server, displaying a modified essay defined by the modified first essay data entity to a second user, the modified essay displaying the ordered set of original groupings with the additional grouping being visually distinguished from the original groupings.

13. The method of claim 11, further comprising:
g) at the computer server, receiving a request from an author user associated with an author user data entity to alter the original groupings;
h) at the computer server, using permission data entities to verify that the author user data entity has permission to alter the original groupings;
i) at the computer server, altering one of the original groupings to incorporate the additional content; and
j) at the computer server, displaying an altered essay including the altered one of the original groupings.

14. The method of claim 11, further comprising:
g) at the computer server, receiving a request from an author user associated with an author user data entity to alter the original groupings;
h) at the computer server, using permission data entities to verify that the author user data entity has permission to alter the original groupings;
i) at the computer server, altering the modified first essay data entity to insert the additional grouping into the ordered set of original groupings; and
j) at the computer server, displaying the altered essay defined by the altered modified first essay data entity.
